(19) United States
(12) Patent Application Publication
(10) Pub. No.: US 2007/0295147 A1
(43) Pub. Date: Dec. 27, 2007

(54) Joystick Device With Electric Latching Detents

(75) Inventors: Stanley N. Didier, Plymouth, MN (US); Wayne Edmunds, Gwent (GB); Terence K. Pontin, Gwent (GB)

Correspondence Address: ZARLEY LAW FIRM P.L.C., CAPITAL SQUARE, 400 LOCUST, SUITE 200, DES MOINES, IA, 50309-2350, US

(73) Assignees: Sauer-Danfoss Inc., Ames, IA (US); Penny & Giles Control Ltd., Cwmfelinfach, Gwent (GB)

(21) Appl. No.: 10/592,595

(22) PCT Filed: Mar. 11, 2005
(86) PCT No.: PCT/US05/07865

§ 371 Date: Jun. 1, 2007

Related U.S. Application Data
(60) Provisional application No. 60/552,468, filed on Mar. 12, 2004.

(51) Int. Cl. G05G 5/06; G05G 19/00

(52) U.S. Cl. 74/519; 74/527

(57) ABSTRACT

A joystick (1) having a yoke pivotally secured to an upper support (28) and a lever (16) pivotally secured to a lower support. The yoke has a latching portion that engages a cam roller (14) on the lever to push the lever downward. Supported on the lever is an armature (24) positioned in spaced relation to a solenoid (26). The solenoid is energized based on the movement of the yoke.

### CROSS REFERENCE TO RELATED APPLICATIONS

This application claims the benefit of U.S. Provisional Application No. 60/552,468, filed Mar. 12, 2004.

### BACKGROUND OF THE INVENTION

Machine operators of off-road equipment such as tractors and loaders have come to expect certain functionality in the heavy machinery, particularly the operation of attachments and various work functions. For example, the operator of a backhoe loader controls the position of the bucket by affecting the position of a control lever or joystick. Conventional control levers consist of a hydraulic valve that an operator manipulates, causing various actuators to affect the position of the bucket. Certain positions of the control lever will cause the machine to place the bucket in corresponding positions.

The position at the end of the control lever's travel often is referred to as the detent position. The control lever generally stays in the detent position until the bucket has reached its corresponding position, at which point the control lever returns to its at-rest position. Conventional control levers included an integrated hydraulic valve, whereby the hydraulic flow forces in the valve accomplished the task of returning the control lever to the at-rest position. More recently, joystick devices have incorporated electronic solenoid valves to electro-magnetically “latch” the joystick into the detent position. In this arrangement, an electronic signal from a sensor or a micro controller is used to release the solenoid and return the joystick to the at-rest position.

Conventional control levers and joysticks still rely upon an integrated hydraulic valve, though, to ultimately affect the position of the bucket or other heavy machinery attachment. It is therefore a primary object of this invention to create a joystick that uses electronic sensors and not hydraulic valves for controlling heavy machinery.

### SUMMARY OF THE INVENTION

A joystick device having an upper support and a lower support having a yoke pivotally secured to the upper support and a lever pivotally secured to a lower support. The yoke has at least one latching portion that engages a cam roller on the lever to move the lever downward. The lever is normally maintained in an upward position by a spring. An armature is supported by the lever and is in parallel spaced relation to a solenoid. A micro controller senses the movement of the yoke and energizes the solenoid.

### BRIEF DESCRIPTION OF THE DRAWINGS

FIG. 1 is a side view of the joystick of the present invention.

### DETAILED DESCRIPTION OF THE INVENTION

The joystick 1 uses a gimble-type mechanism, whereby the joystick movement is created and controlled by a pair of yokes mounted at 90° with respect to one another. In this arrangement, one of the yokes pivots about its main axis and swings through an arc when the joystick is moved in a forward or reverse direction (Y-axis), and the other yoke pivots about its main axis and swings through an arc when the joystick is moved in a left or right direction (X-axis). The joystick is equipped with electronic sensors that measure the position of the yokes to provide the desired electrical proportional signal. A micro controller 2 in the joystick processes this signal for use by the machine, valve, or other main controller. The micro controller also may process the signal for solenoid actuation, as discussed below. A main spring, not shown, provides the means for returning the joystick and yokes to an at-rest position, which is a neutral position where the yokes are essentially centered between the forward/reverse and left/right positions.

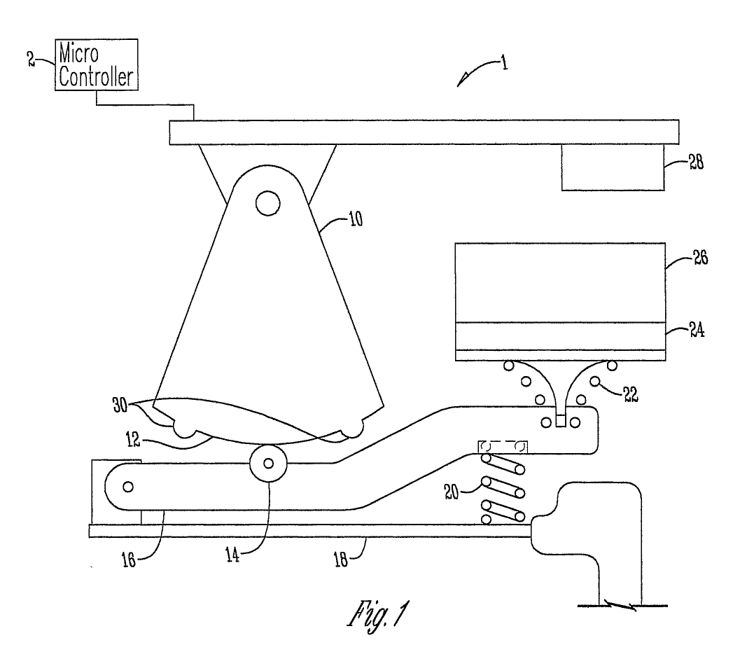

As shown in FIG. 1, a yoke 10 is provided with a yoke cam profile 12. A cam roller 14 rides along the yoke cam profile as the joystick is moved from the at-rest position to a full travel position. This cam profile 12 may be tailored to give the desired operating feel depending upon the application. The yoke cam 12 profile also may be tailored to give different operating features for the forward (+) and the reverse (−) movement of the joystick.

The cam roller 14 is supported by a lever 16. The lever 16 pivots about the lower support 18 and is held against the cam roller 14 and yoke cam profile 12 by a spring 20. The spring 20 is preloaded to overcome the effects of gravity and vibration, thereby ensuring that the cam roller 14 is always in contact with the yoke 10.

An alignment mechanism 22 is attached to the lever 16 and supports the armature 24. The alignment mechanism 22 maintains the armature 24 and solenoid 26 in parallel spaced relation to one another for proper operation and coupling. The pole piece, or main body of the solenoid 26, is attached to the upper support 28 of the joystick 1. When the solenoid 26 is energized, the armature 24 becomes magnetically coupled to the pole piece, which prevents the lever from pivoting. Depending on the cam profile 12 and the position of the yoke 10, preventing the lever from pivoting holds the joystick in the detented position.

In operation, the operator manipulates the joystick, thereby causing one of the yokes 10 to pivot. In the at-rest position, the solenoid 26 is not energized. As the cam roller 14 engages with the latch 30 on the yoke cam profile 12, the cam roller 14 forces the lever 16 downward and compresses the spring 20. The micro controller will sense that the position of the yoke 10 is nearing the detent position and will energize the solenoid 26. Because the lever is down, however, the armature 24 and the main body of the solenoid 26 will not couple. As the operator continues to manipulate the joystick, the cam roller 14 moves past the latch 30 on the yoke cam profile 12 and the spring 20 returns the lever 16 to its upward position. Continued movement will cause the armature 24 and the solenoid 26 to come in close enough proximity to each other so that the coupling occurs, latching the joystick in the detent position.

Once in the detent position, the operator may release the joystick 1 by exerting force to pull the joystick out of the detent. The joystick also may be electrically removed from the detent by de-energizing the solenoid 26. The loss of the electrical signal to the solenoid 26 will cause the magnetic coupling to cease, and the main spring (not shown) in the joystick has sufficient force to return the joystick to the at-rest state.

What is claimed is:

1. A joystick device having an upper support and a lower support comprising: a yoke pivotally secured to the upper support and having at least one latching portion; a lever pivotally secured to the lower support and being maintained in an upward position by a spring; a solenoid armature supported by the lever and in parallel spaced relation with a solenoid; a cam roller in engagement with both the yoke and the lever wherein the latching portion causes the cam roller to move the lever downward; and a micro controller that senses the movement of the yoke and energizes the solenoid.

2. The device of claim 1 wherein an alignment mechanism is attached to the armature.
